(19) United States
(12) Patent Application Publication
(10) Pub. No.: US 2003/0177345 A1
(43) Pub. Date: Sep. 18, 2003

(54) Method for updating a BIOS in a notebook computer

(75) Inventor: Tsung-Sheng Huang, Hsin-Chuang City (TW)

Correspondence Address: Eugene Mar, BACON & THOMAS, PLLC, Fourth Floor, 625 Slaters Lane, Alexandria, VA, 22314-1176, US

(73) Assignee: INSYDE SOFTWARE CORP., Taipei (TW)

(21) Appl. No.: 10/192,719

(22) Filed: Jul. 11, 2002

(30) Foreign Application Priority Data
Mar. 13, 2002 (TW) 91104676

(51) Int. Cl. G06F 9/445

(52) U.S. Cl. 713/2

(57) ABSTRACT

A method for updating a basic input/output system (BIOS) in a notebook computer is introduced. The notebook computer includes a keyboard controller and a read only memory (ROM) storing the BIOS. A foreign computer is utilized to update the BIOS of the notebook computer. The method includes a step of resetting the keyboard controller, a step of determining whether or not the BIOS needs to be updated, a step of initializing the keyboard controller for preparing the ROM to be updated in the case that the BIOS needs to be updated, a step of the keyboard controller handshaking a foreign computer for receiving a command and a data and updating the ROM, and a step of determining through the foreign computer whether or not the ROM has been completely updated. If the ROM has been completely updated, then the method goes back to the step of resetting the keyboard controller. Otherwise, the method goes back to the step of having the keyboard controller re-handshake the foreign computer for receiving the command and the data and thereafter update the ROM.

### BACKGROUND OF THE INVENTION

(1) Field of the Invention

The invention relates to an updating method for a basic input/output system (BIOS), and more particularly to a method that is applied to update the BIOS of a notebook computer.

(2) Description of the Prior Art

It is well known that a keyboard controller (KBC) of a notebook computer is used to manage system's commands and data, to receive data sent from a personal system/2 (PS/2) keyboard or a PS/2 mouse, and to forward commands and data to the PS/2 keyboard or mouse in accordance with the system's commands. Also, the keyboard controller of the notebook computer may need to take charge in scanning of a keyboard matrix, controlling, managing and even re-charging/discharging of power.

Referring to FIG. 1, a block diagram is used to show part of the system of a conventional notebook computer. During the development stage of the system for the notebook computer 100, a read-only memory (ROM) 102 of the notebook computer 100 stores a BIOS 104 for a keyboard controller 108 and another BIOS 106 for internal system of the notebook computer 100. While the BIOSs 104 and 106 of the ROM 102 (for example, a flash memory) are updated, the ROM 102 is firstly moved to an electrically erasable programmable ROM writer (not shown in FIG. 1), known as the EEPROM writer, for writing the BIOSs 104 and 106 into the ROM 102. After the writing is completed, the ROM 102 is then moved to anchor at a socket (not shown in FIG. 1) of a mother board. In the case that the notebook computer 100 fails to be turned on, the ROM 102 needs to be removed from the socket and then to be relocated in the EEPROM for re-writing. Nevertheless, such an reiterated writing process always consumes lots of time and additional cost is also required at this stage for preparing a socket of the flash memory.

In addition, after the notebook computer 100 is turned on and also after an operating system (OS) is booted, the BIOS of the notebook computer 100 can use a flash utility to update the BIOS in the ROM 102. In the case that the BIOS has been updated but the notebook computer 100 cannot be restarted with the updated BIOS, the ROM 102 is required to be removed from the notebook computer 100 for further rewriting. In the case that the notebook computer 100 has already been assembled, then disassembling of the notebook computer 100 is inevitable. Such assembling or disassembling upon the notebook computer 100 is notorious and time-consuming (at least one hour), even for the persons skilled in the art. If the concerned notebook computer 100 is at the stage of mass production, the flash memory (equally, the ROM 102) requires to be removed and then to be rewritten before it can be welded into the notebook computer 100.

Accordingly, the present invention presents a method for updating the BIOS of the notebook computer, in which a keyboard controller for controlling the rewriting is used as an interface. The data required for the rewriting is sent to the keyboard controller from another computer through the transmission interface.

### SUMMARY OF THE INVENTION

Accordingly, it is a primary object of the present invention to provide a method for updating a BIOS in the notebook computer.

In accordance with the present invention, the notebook computer includes a keyboard controller and a read only memory (ROM). The BIOS is written in the ROM. First of all, the method of the present invention is to reset the keyboard controller. Then, the question whether or not the BIOS needs to be updated is determined. If positive, the keyboard controller is then initialized so that the ROM can be updated. Further, the keyboard controller handshakes a foreign computer for receiving a command and a data and then updates the ROM. In addition, the foreign computer is utilized to determine whether or not the ROM of the notebook computer has been completely updated. In the case that the ROM has been completely updated, then the method goes back to the step of resetting the keyboard controller. In the case that the ROM is not completely updated, the method goes back to the step of having the keyboard controller re-handshake the foreign computer for receiving the command and the data and thereafter update the ROM.

By providing the updating method of the present invention, the socket for ROM as mentioned in the background section can be waived in the system development stage and thus a substantial amount of money can be saved. Also, while the system is down and the notebook computer can not be started, the method of the present invention provides a more convenient method to cut down the time for re-writing the flash memory.

All these objects are achieved by the method for updating BIOS in the notebook computer described below.

### BRIEF DESCRIPTION OF THE DRAWINGS

The present invention will now be specified with reference to its preferred embodiment illustrated in the drawings, in which

FIG. 1 is a block diagram for a partial system of a conventional notebook computer;

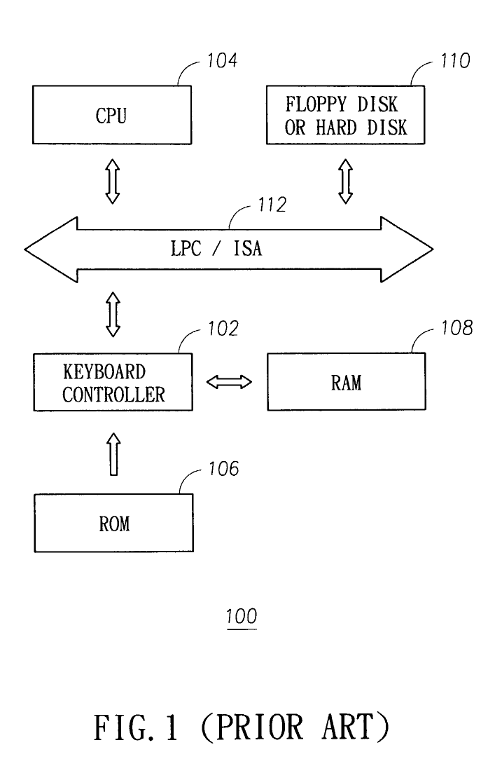

FIG. 2 is a block diagram for a preferred embodiment of the method for updating BIOS in the notebook computer in accordance with the present invention; and

FIG. 3 is a flowchart of a preferred embodiment of the method for updating BIOS in the notebook computer in accordance with the present invention.

### DESCRIPTION OF THE PREFERRED EMBODIMENT

The invention disclosed herein is directed to a method for updating a BIOS in a notebook computer. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

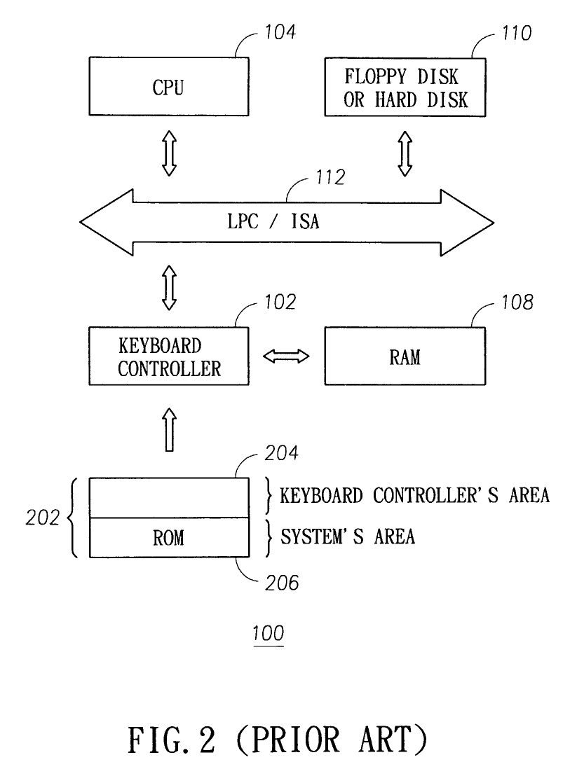

Referring now to FIG. 2, a block diagram for a preferred embodiment of the method for updating the BIOS in the notebook computer in accordance with the present invention is illustrated. As shown, the keyboard controller 202 and a low pin count/industry standard architecture (LPC/ISA) bus 204 are electrically connected. Through a bus 206, the keyboard controller 202 and the LPC/ISA bus 204 can be used to transit/receive commands/data. In the present invention, the keyboard controller 202 can also be a microprocessor. The ROM 208 which can be a flash memory includes an internal BIOS 212 of the notebook computer 200 and a BIOS 210 of the keyboard controller 202. It is noted that the BIOS 210 of the keyboard controller 202 can be alternatively stored in another ROM (not shown in FIG. 2) belonged to the keyboard controller 202, in which the ROM is independent and not included in the ROM 208. As shown, the keyboard controller 202 can utilize a bus 214 to read uni-directionally programs or functions stored in the ROM 208. When the programs or the functions stored in the ROM 208 needs to be rewritten (i.e., to be updated), the keyboard controller can use the bus 214 to write the programs or the functions, in a reverse direction, into the ROM 208.

In the preferred embodiment shown in FIG. 2, a foreign computer 216 is used to have the keyboard controller 202 update the programs or the functions stored in the ROM 208. Upon such an arrangement, two advantages as follows can be achieved.

(1) The internal EEPROM (i.e. ROM 208) of the product notebook computer 200 is firstly prepared by an EEPROM writer (not shown in Figures), and then is installed to the socket. If updating of the programs or the functions in the EEPROM is required in the future, it is not necessary to remove the EEPROM from the socket for further being re-written in the EEPROM writer, as described in the background section.

(2) After the programs or the functions in the EEPROM are updated and in the case that the BIOS fails to restart the notebook computer, it is only necessary to have the foreign computer update once more the programs or the functions stored in the EEPROM. Again, removing the EEPROM from the socket for further being re-written in the EEPROM writer is no longer necessary.

Firstly, in the present invention, the keyboard controller 202 must store in advance a program for receiving commands from the foreign computer. Upon such an arrangement, the computer 216 and the keyboard controller 202 of FIG. 2 can perform command/data transmission in between, i.e. the BIOS function. The interface for such a transmission can be a parallel port, a serial port, a system management bus 218, a universal serial bus (USB) 220, or any the like. By providing the program and the selected interface, the computer 216 can have the keyboard controller 202 update the programs or the functions in the ROM 208. For example, in the case that the keyboard controller 202 is supported by a parallel port interface, the computer 216 can use the parallel port 218 and the keyboard controller 202 to perform data transmission. Upon such an arrangement, a connecting part (not shown) of a circuitry (not shown) connecting the keyboard controller 202 to a keyboard (not shown) is electrically connected with the parallel port 218. Thereby the computer 216 can communicate with the keyboard controller 202, and thus the commands/data as well as related addresses to be written to the ROM 208 can be forwarded from the computer 216 to the keyboard controller 202. Thereafter, the keyboard controller 202 can write the data obtained from the computer 216 into the ROM 208. Similarly, firmware for the keyboard controller can also be written into the BIOS 210 belonged to the keyboard controller 202. Upon such an arrangement, the system's BIOS or the firmware of the keyboard controller can be updated, even though the notebook computer 200 cannot be turned on. Equally, for another example, in the case that the keyboard controller 202 is supported by a serial port interface, the computer 216 can utilize the serial port 218 and the keyboard controller 202 to perform data transmission. Under this circumstance, a universal synchronous/asynchronous receiver/transmitter (USART, not shown) of the keyboard controller 202 is electrically connected with the serial port 218, and thereby communication between the computer 216 and the keyboard controller 202 can be established. Therefore, the commands/data as well as related addresses to be written to the ROM 208 can be forwarded from the computer 216 to the keyboard controller 202, and thus the keyboard controller 202 can write the data obtained from the computer 216 into the ROM 208. Similarly, firmware for the keyboard controller can also be written into the BIOS 210 of the keyboard controller 202. Upon such an arrangement, the system's BIOS or the firmware of the keyboard controller can be updated, even though the notebook computer 200 cannot be turned on. Similarly, in the case of using a system management bus 218 to support the data transmission, the mechanism is similar to those described above, hence detailed description is therefore omitted. By viewing the specifications of the notebook computers 200 in the market, it is noted that the keyboard controller 202 is seldom supported by the USB interface. Therefore, in the case that the computer 216 utilizes the USB 220 to transmit data, the communication between the computer 216 having the USB 220 and the keyboard controller 202 can not be established directly through a USB protocol. In replacement, the communication therebetween can only be established by utilizing a parallel port/serial port via the USB 222, i.e. to transform the USB interface into a parallel port interface or a serial port interface. Thereby, the computer 216 can then communicate with the keyboard controller 202, and, upon such an arrangement, the system's BIOS or the firmware of the keyboard controller can be updated, even though the notebook computer 200 cannot be turned on. Thereafter, in the case that the keyboard controller 202 is indeed supported by the USB interface, it can communicate directly with the interface of the USB 220 of computer 216, and no more transforming the USB interface into the parallel/serial port interface via transforming the USB into the parallel/serial port 222 is required.

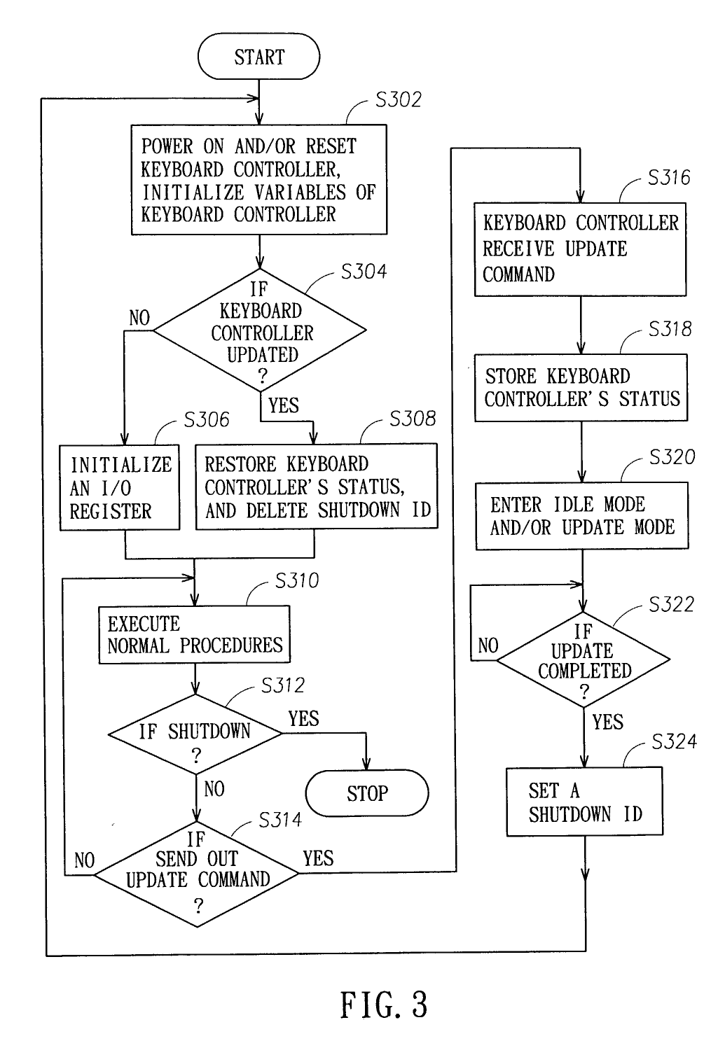

Referring now to FIG. 3, a flow chart of the preferred embodiment of FIG. 2 in accordance with the present invention is shown. Firstly, to reset the keyboard controller 202, a power (AC 110 V) is cabled to the notebook computer 200 in advance, and then a power button (not shown) of the notebook computer 200 is pressed for a period of time. Upon such an action, the keyboard controller 202 can aware that the BIOS is going to be updated (S302). Then, the keyboard controller 202 is proceeded to determine whether or not the BIOS in the ROM 208 needs to be updated (S304). When the keyboard controller 202 is going to update the BIOS in the ROM 208, a keyboard controller 102 begins to read commands/data from an initial address of the BIOS 210 belonged to the keyboard controller 202 so as to initialize the variables in the registers inside the keyboard controller 202 and further to execute the program for receiving commands transmitted from the foreign computer 216. At this stage, the keyboard controller 202 is now ready to update the ROM 208 (S306). Then, the keyboard controller 202 handshakes the foreign computer 216 by utilizing an interface such as a parallel port, a serial port, a system management bus 218 or a USB 220, so that the keyboard controller 202 can obtain commands/data from the foreign computer 216 for updating, i.e. rewriting, the BIOS in the ROM 208 (S308). Further, the computer 216 can inform the keyboard controller 202 whether or not the BIOS in the ROM 208 is completely updated (S310). As soon as the computer 216 acknowledges the keyboard controller 202 that the updating of the BIOS in the ROM 208 is completed, the method goes back to step S302. If the computer 216 does not acknowledge the keyboard controller 202 about the completion of updating the BIOS in the ROM 208, the method goes back to step S308.

In the case that the keyboard controller 202 does not intend to update the BIOS in the ROM 208, i.e. the power button of the notebook computer 200 is not pressed while the keyboard controller 202 is resetting, then checking the ROM with respect to the keyboard controller 202 (i.e. the BIOS 210 of the keyboard controller 202) is performed. If the checksum is correct, the method jumps to the address of an executing code with respect to the keyboard controller 202 (S312). Then, a normal operative procedure is performed by the keyboard controller 202. The normal operative procedure may include managing system's command and data, receiving data sent from a PS/2 keyboard or a PS/2 mouse (not shown), forwarding command and data to the PS/2 keyboard or mouse in accordance with the system's command, and so on (S314). Finally, the method can determine whether or not the notebook computer 200 needs to be turned off. In the case that the notebook computer 200 needs to be turned off, the notebook computer 200 can be directly powered off if it is a DOS system, or the notebook computer 200 can be turned off after going through a normal power-off procedure of the Windows system if it is a Windows operation system. On the other hand, in the case that the notebook computer 200 does not need to be turned off, then the method goes back to step S314.

By providing the updating method of the present invention, one of the various advantages is that the socket for testing ROM can be waived in the system development stage and thus a substantial amount of money can be saved. Another advantage of the present invention is that, while the updated system cannot restart the notebook computer, a foreign computer can be introduced to update the BIOS. Therefore, the method of the present invention provides a more convenient method to cut down the time for rewriting the flash memory.

While the present invention has been particularly shown and described with reference to a preferred embodiment, it will be understood by those skilled in the art that various changes in form and detail may be without departing from the spirit and scope of the present invention.

I claim:

1. A method for updating a basic input/output system (BIOS) in a notebook computer, the notebook computer including a keyboard controller and a read only memory (ROM), the BIOS being written in the ROM, the method comprising the steps of:
(a) resetting the keyboard controller;
(b) determining whether or not the BIOS needs to be updated;
(c) initializing the keyboard controller for preparing the ROM to be updated in the case that the BIOS needs to be updated;
(d) having the keyboard controller handshake a foreign computer for receiving therefrom a command and a data, and update the ROM;
(e) determining through the foreign computer whether or not the ROM has been completely updated;
(f) back to step (a) in the case that the ROM is completely updated; and
(g) back to step (d) in the case that the ROM is not completely updated.

2. The method for updating a BIOS in a notebook computer according to claim 1, wherein said keyboard controller is a microprocessor.

3. The method for updating a BIOS in a notebook computer according to claim 1, wherein said ROM includes the read only memory located inside said keyboard controller.

4. The method for updating a BIOS in a notebook computer according to claim further includes the steps of:
(h) in the case that said BIOS needs not to be updated, checking another read only memory of said keyboard controller with respect to said keyboard controller, and jumping to an executing code of said keyboard controller if the checksum is correct;
(i) said keyboard controller executing a normal operative procedure;
(j) determining whether or not said notebook computer needs to be turned off;
(k) turning off said notebook computer in the case that said notebook computer needs to be turned off; and
(l) back to step (i) in the case that said notebook computer needs not to be turned off.

5. The method for updating a BIOS in a notebook computer according to claim 1, wherein in said step (d), said command and said data are transmitted through a parallel port, a serial port, a system management bus or a universal serial bus.

6. The method for updating a BIOS in a notebook computer according to claim 1, wherein a receiving program is stored in said ROM for performing said step (d).
